(19) United States
(12) Patent Application Publication
(10) Pub. No.: US 2012/0019203 A1
(43) Pub. Date: Jan. 26, 2012

(54) ENERGY STORAGE AND VEHICLE CHARGING SYSTEM AND METHOD OF OPERATION

(75) Inventor: A. Arthur Kressner, Westfield, NJ (US)

(73) Assignee: CONSOLIDATED EDISON COMPANY OF NEW YORK, INC., New York, NY (US)

(21) Appl. No.: 12/841,512

(22) Filed: Jul. 22, 2010

(51) Int. Cl. H02J 7/00

(52) U.S. Cl. 320/109

(57) ABSTRACT

An energy storage system for a substation on an electrical power network is provided. The energy storage system is coupled to receive and store electrical power. The stored electrical power may then be used to either charge vehicles or meeting the needs of other discretionary or interruptible loads with an electric propulsion, or to provide electrical power a feeder connected to essential service loads such as police stations, hospitals and traffic control. In one embodiment, the substation also utilizes the energy storage system in a peak shaving mode of operation.

### BACKGROUND OF THE INVENTION

The subject matter disclosed herein relates to a system and method for storing excess electrical production capacity for use as a flexible energy source, and in particular to a system that may be used for charging electric based vehicles and integrating solar and wind energy resources for providing electrical power to important infrastructure assets.

The current electrical power network has an expansive infrastructure that delivers electrical power produced by a few large centrally located power generation facilities to a large number of geographically dispersed consumers. In general, the electric power network can be broken into two portions, a transmission system and, a distribution system. The transmission system transfers high voltage (e.g. >135 kV) electrical power over long distances from the power generation plant to the area where the energy will be consumed. The electrical power is transferred at high voltages to minimize the losses that will occur as the electrical energy flows through the conductors. The transmission system typically consists of aluminum or copper conductors that may be either routed underground, or be suspended overhead. The transmission system terminates at a facility referred to as an electrical substation.

An electrical substation transitions electrical power from the high voltages used in transmission to a lower voltage (e.g. 2 kV-33 kV) that may be carried by the distribution system. Depending on the architecture of the local systems, the electrical utility may employ multiple levels of substations. Electrical substations include equipment that allows for switching, routing, protection and control of the electrical power. This equipment includes circuit breakers, buses, transformers and feeders for example. Generally, the incoming electrical power is divided among the feeders, which then deliver the electrical power to local distribution lines.

Electrical substations are often physically quite large, with some substations occupying several acres of land. The need for a large physical space was driven originally by equipment needs and spacing distances required for safe operation. As technology has improved, the smaller size of electrical distribution equipment has resulted in utilities under utilizing their real estate.

The electrical power network is transitioning from configuration discussed above where power is produced by a few large power generation facilities to a more distributed arrangement where smaller producers, including those using renewable energy sources, provide a larger portion of the energy needed to meet demand. While these newer sources of electrical generation provide many benefits, it is often difficult to match the level of energy produced to level of demand. Further, unlike traditional power sources, those that produce electrical energy from renewable sources can only generate when the resource is available, which may not correspond to times of increase demand. This problem is further compounded by increases in levels of electrical demand brought about by newer technologies, such as electric vehicles.

While existing electrical substations are adequate for their intended purposes there remains a need for improvements, particularly regarding the storage of electrical power and the charging of electric vehicles.

### BRIEF DESCRIPTION OF THE INVENTION

According to one aspect of the invention, an energy storage system is provided. The system includes an energy distribution facility, the facility having at least one energy input and a plurality of energy outputs. An energy storage device is coupled to the at least one energy input and at least one of the plurality of energy outputs. A charging station is associated with the facility, the charging station is configured to removably couple the energy storage device in one or more electric vehicles.

According to another aspect of the invention, an electrical substation is provided. The substation includes at least one electrical power input. A plurality of transformers are electrically coupled to the at least one electrical power input. A plurality of feeders are electrically coupled to receive electrical power from the plurality of transformers and transmit electrical power to an end load. An energy storage device is electrically coupled to the at least one electrical power input. A charging station is operably coupled to the energy storage device, the charging station being configured to transfer electrical energy to at least one electrically powered vehicle.

According to yet another aspect of the invention, an electrical substation adjacent a publicly accessible roadway is provided. The substation includes an electrical source input line. Electrical equipment is electrically coupled to the input line. A plurality of feeders are electrically coupled to the electrical equipment, the plurality of feeders including a first feeder circuit. An energy storage device is electrically coupled to the electrical equipment and the first feeder circuit. A charging station is arranged adjacent the roadway, the charging station being operably coupled to the energy storage device and at least one electrically powered vehicle. A controller having a processor is responsive to executable instructions, the executable instructions when executed on the processor for transferring electrical energy from the energy storage device to the charging station when electrical power is available from the electrical source input line.

According to yet another aspect of the invention, a method of operating an electrical substation and vehicle charging system is provided. The method includes receiving electrical energy from a source. Electrical energy is stored in an energy storage device. Electrical energy is transferred from the energy storage device to a vehicle. A first feeder is coupled to the energy storage device and the source. Electrical energy is transferred from the source to the first feeder. Electrical energy is transferred from the energy storage device when there is a disruption in the transfer of electrical energy from the source.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of an electrical network;

FIG. 2 is a schematic illustration of an electrical substation of FIG. 1 in accordance with one embodiment of the invention;

FIG. 3 is a schematic illustration of an electrical substation of FIG. 1 in accordance with another embodiment of the invention;

FIG. 4 is a schematic illustration of an electrical substation of FIG. 1 in accordance with another embodiment of the invention;

FIG. 5 is a state diagram illustration for the operation of the electrical substation of FIGS. 1-4 in accordance with an embodiment of the invention; and,

FIG. 6 is a demand curve illustration for an exemplary electrical demand for the electrical network of FIG. 1.

The detailed description explains embodiments of the invention, together with advantages and features, by way of example with reference to the drawings.

### DETAILED DESCRIPTION OF THE INVENTION

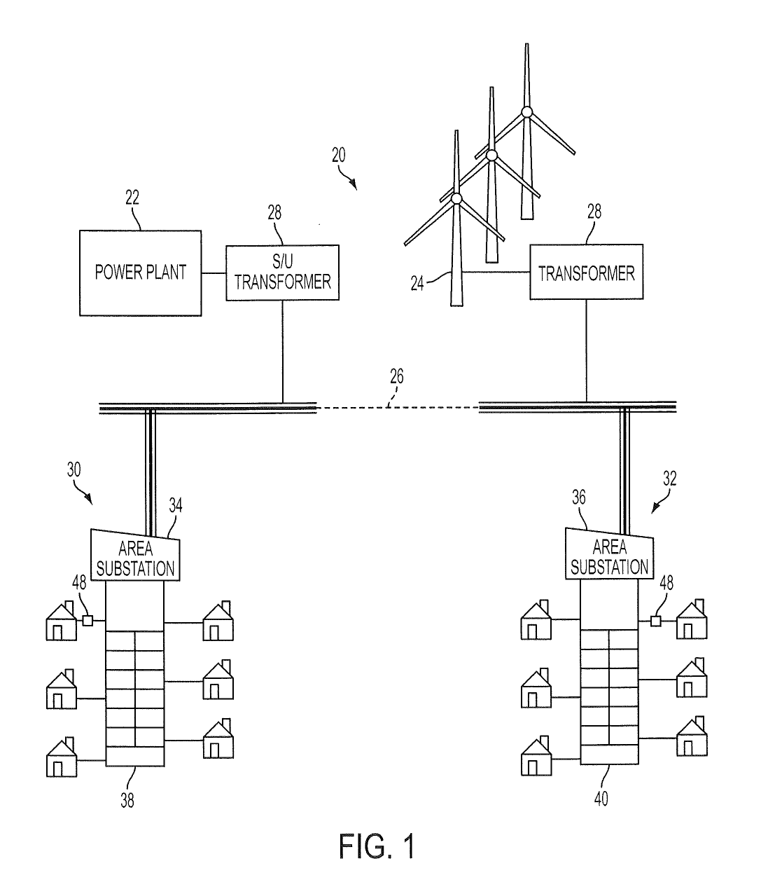

FIG. 1 illustrates an exemplary embodiment of a utility electrical transmission and distribution system 20. The system 20 includes one or more electric power generation facilities 22 connected in parallel to a main transmission system 26 by multiple step-up transformers 28. The power generators 22 may include, but are not limited to: coal, nuclear, natural gas, or incineration power plants. Additionally, the system 20 may include power generation facilities 24 that utilize renewable energy sources, such as hydroelectric, solar, or wind turbine power generators. The step-up transformers 28 increase the voltage from that produced by the power generators 22, 24 to a high voltage, such as 138 kV for example, to allow long distance transmission of the electric power over main transmission system 26. It should be appreciated that additional components such as transformers, switchgear, fuses and the like (not shown) may be incorporated into the transmission and distribution system 20 as needed to ensure the safe and efficient operation of the system. The transmission and distribution system 20 is typically interconnected with one or more other utility networks to allow the transfer of electrical power into or out of the transmission and distribution system 20.

The main transmission system 26 typically consists of high voltage transmission power lines, anywhere from 69 KV to 500 KV for example, and associated transmission and distribution equipment which carry the electrical power from the point of production at the power generators 22, 24 to the end users located on local electrical distribution systems 30, 32. The local distribution systems 30, 32 are connected to the main distribution system by area Substations 34, 36 that are connected to the first distribution system 30 and second distribution system 32 respectively. The area Substations 34, 36 reduce the transmission voltage to distribution levels such as 13 KV, 27 KV or 33 KV for the end users. Area Substations 34, 36 typically contain three or more transformers, switching, protection and control equipment as well as circuit breakers to interrupt faults such as short circuits or over-load currents that may occur. Substations 34, 36 may also include equipment such as fuses, surge protection, controls, meters, capacitors, load tap changers, phase-angle meters, and voltage regulators. As will be discussed in more detail below, the substations 34, 36 may include energy storage capabilities to allow delivery of electrical power to at least portions of the distribution systems 30, 32 in the event of a loss of electrical power from the main transmission system 26.

It should be appreciated that the Substations 34, 36 may both be connected to a single electrical power generation plant, such as power generator 22 for example. Alternatively, they may be connected to the main transmission system 26 such that the Substations 34, 36 receive electrical power from different power stations, such as substation 34 receives electrical power from power generator 22 and substation 36 receives electrical power from renewable energy power generator 24 as illustrated in FIG. 1 for example.

The area Substations 34, 36 connect to one or two local electrical distribution networks 38, 40 respectively. These local electrical distribution networks 38, 40 provide electrical power to an area, such as a residential, commercial or mixed-use area for example. The local electrical distribution networks 38, 40 also include additional equipment, such as transformers 48 that adapt the voltage from the Substations 34, 36 output to one usable by the end customers. For example, the substation 34 may distribute electrical power at 13 kV. The transformer 48 lowers the voltage to 120V/208V, which is usable by a residence for example. The local electrical distribution networks 38, 40 may further have isolated end users. The area substation 34 typically has a plurality of feeder circuits that provide electrical power to multiple local networks.

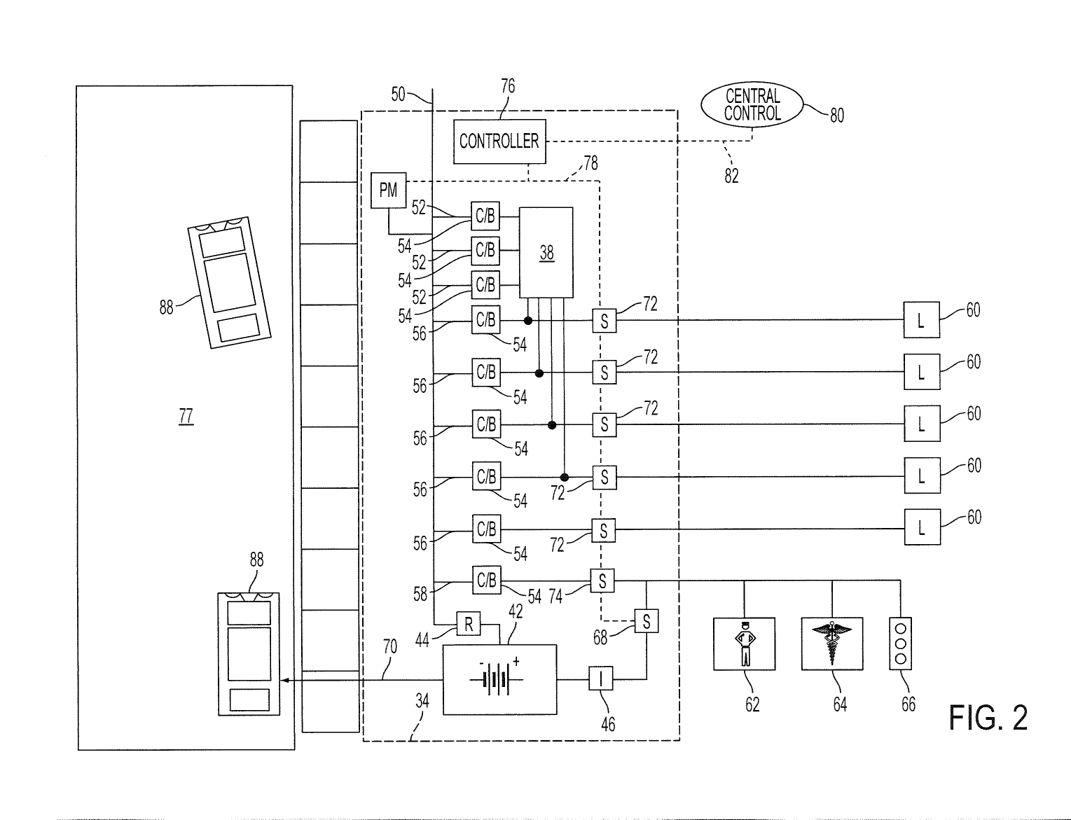

Referring now to FIG. 2, an exemplary substation interconnection system will be described with respect to substation 34. It should be appreciated that substation 36 may be configured in substantially the same manner. The substation 34 receives electrical power from the main transmission system 26 via connection 50. The received electrical power is then divided between feeders 52, 56, 58. A feeder is a device that allows the utility to receive the incoming electrical power and subdivide the electrical power into discrete branch circuits connected to the substation 34. In the exemplary embodiment, several of the feeders 52 transfer power into circuits that connect to the local distribution network 38. Usually, each feeder 52, 56, 58 includes a circuit breaker 54 that allows the connection and disconnection of the substation from the local network 38.

Some of the feeders 56 may be further coupled to loads, such as isolated loads 60 for example, via medium voltage switches 72. A third type of feeder 58 connects connection 50 to another set of loads 62, 64, 66 via medium voltage switch 74. As will be discussed in more detail herein, in the exemplary embodiment, the loads 62, 64, 66 may be public infrastructure services types of loads, such as a police station 62, hospital 64, communication and data systems and traffic control systems 66. Other types of public or emergency services could include street lighting and surveillance cameras for example.

In addition to the feeders, circuit breakers and switches described above, substation 34 may also include equipment such as fuses, surge protection, controls, electrical demand meters, phase angle meters, capacitors, and load tap changers for voltage regulation.

Also coupled to the connection 50 and the feeder 58 is an energy storage device 42. In the exemplary embodiment, the energy storage device 42 receives electrical power from the connection 50 and retains the energy for later use. The energy storage device 42 may be a battery, including but not limited to a wet cell, a dry cell, or a molten salt type of battery for example. The energy storage device 42 may be comprised of a series of batteries arranged in parallel or in series. The batteries may be substantially non-removable, or removable as is discussed below. The energy storage device 42 may further be include or be comprised of other types of energy storage devices, such as one or more ultracapacitors, supercapacitors, magnetic energy storage (SMES), fuel cells, regenerative fuel cells, flywheels or compressed or liquid air energy storage for example. The energy storage device 42 may further be a flow cell type battery having a rechargeable electrolyte.

In the exemplary embodiment, the energy storage device 42 is coupled to the connection 50 by a power conversion device, such as a rectifier or motor generator (MGS) 44 for example. The rectifier or MGS 44 receives electrical power in the form of alternating current (AC) and converts the electrical power into direct current (DC) form for storage in the batteries of energy storage device 42. It should be appreciated that the energy storage device 42 may include additional control circuitry that allows for the efficient distribution, storage, monitoring and operation of the energy storage device 42 as is known in the art.

The energy storage device 42 also includes a first output coupled to another power conversion device, such as inverter 46 for example. The inverter or MGS 46 receives the DC electric power from the energy storage device and converts it into AC electric power having the desired characteristics to be appropriate for use on feeder 58. A medium voltage switch 68 connects the inverter 46 to the feeder 58. It should be appreciated that switches 68, 74 are operated such that feeder 58 receives electrical power from either the connection 50 directly or from the energy storage device 42.

As will be discussed in more detail below, the energy storage device 42 includes a second output connection 70. The output connection 70 allows the energy storage device 42 to be coupled to a vehicle 88 that is located adjacent the substation 34, such as in street 77 for example. The output connection 70 may include additional components, such as power converters for example, that control and adapt the flow electrical power. As is discussed in more detail herein, the output connection 70 provides a means for charging vehicles that utilize at least some form of electrical power for propulsion. The vehicle 88 may be an all-electric vehicle, a hybrid vehicle, a plug-in hybrid vehicle, or a fuel cell vehicle for example. As used herein, the term hybrid vehicle refers to a vehicle having both an internal combustion engine and a battery that are used in combination to provide propulsion for the vehicle. It should be appreciated that the energy storage device 42 may have multiple output connections 70 to allow the charging of multiple vehicles 88 simultaneously. Output connections 70 may further additional components or hardware, such as standardized power outlets and user interfaces for example. It should be appreciated that in embodiments where energy storage device 42 is a flow cell battery, appropriate conduits may couple the energy storage device 42 to the vehicle 88 to allow an exchange of the depleted rechargeable electrolyte with charged electrolyte from the energy storage device 42.

Substation 34 also includes a controller 76. The controller 76 may be any suitable device capable of receiving multiple inputs and providing control functionality to multiple devices based on the inputs. Controller 76 includes a processor that is a suitable electronic device capable of accepting data and instructions, executing the instructions to process the data, and presenting the results. The processor may accept instructions through a user interface, or through other means such as but not limited to electronic data card, voice activation means, manually operable selection and control means, radiated wavelength and electronic or electrical transfer. Therefore, the processor can be a microprocessor, microcomputer, a minicomputer, an optical computer, a board computer, a complex instruction set computer, an ASIC (application specific integrated circuit), a reduced instruction set computer, an analog computer, a digital computer, a molecular computer, a quantum computer, a cellular computer, a superconducting computer, a supercomputer, a solid-state computer, a single-board computer, a buffered computer, a computer network, a desktop computer, a laptop computer, or a hybrid of any of the foregoing.

The controller 76 is coupled to communicate with external devices via communications medium 78, these devices include medium voltage switches 68, 72, 74, circuit breakers 54, energy storage device 42, rectifier 44 and inverter 46 for example. Controller 76 may also communicate with external devices, such as a controller associated with substation 36 or a computer at a central control facility 80 via a communications medium 82. Controller 76 may further communicate with vehicle 88. It should be appreciated that the communications mediums 78, 82 may be any suitable communications means, including wired or wireless, capable of quickly and reliably transmitting information. The communications mediums 78, 82 may also be radio connection in the 900 MHz spectrum, a leased telecommunications line (e.g. X.25, T1), a fiber network, a PSTN POTS network, a DSL telecommunications line, a cable telecommunications line, a microwave connection, a cellular connection, or a wireless connection using the IEEE 802.1 standard.

It should be appreciated that while the exemplary embodiment illustrates the controller 76 and central controller 80 as discrete components, these devices may also be integrated into a single device that provides control functionality over substation 34. Further, the functionality of the controller 76 that are described herein may be distributed among several controllers that provide the control functionality. In one embodiment, the controller 76 functionality is distributed into controllers associated with the devices of the substation 34, such as the circuit breakers 54, the medium voltage switches 68, 72, 74, and energy storage device 42 for example.

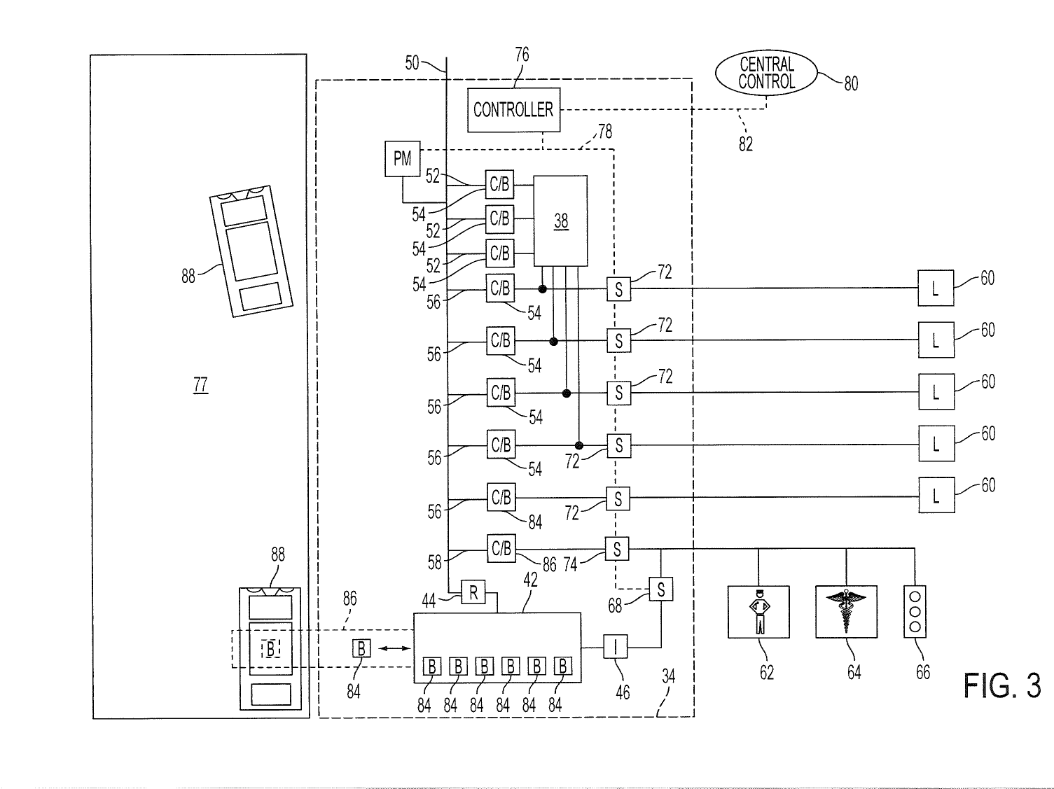

Turning now to FIG. 3, another embodiment of substation 34 will be described. In this embodiment, the energy storage device 42 is comprised of a plurality of discrete, removably connected, batteries 84. The energy storage device 42 is configured to allow the batteries to be moved via a conveyor system or mechanical lifting device 86. The conveyor system or mechanical lifting device 86 moves the batteries 84 out of the substation battery charging rack 34, under or above the street 77 to the waiting vehicle 88. In one embodiment, an automated system removes a depleted or nearly depleted battery from the vehicle 88 and moves the removed battery 84 via the conveyor system or mechanical lifting device 86 to the energy storage device 42 for recharging. With the depleted battery removed, the conveyor system 86 moves a charged battery from the energy storage device 42 and installs it in the vehicle 88.

It should be appreciated that in embodiments where the energy storage device 42 is a flow cell type battery, the substation 34 may include conduits that couple the energy storage device 42 and the vehicle 88. These conduits allow the removal of depleted electrolyte from the vehicle 88 and the transfer of the depleted electrolyte to the energy storage device 42 where the electrolyte is recharged. Other conduits transfer charged electrolyte from the energy storage device 42 to the vehicle 88. Once the depleted electrolyte has been replaced, the vehicle 88 is ready for use.

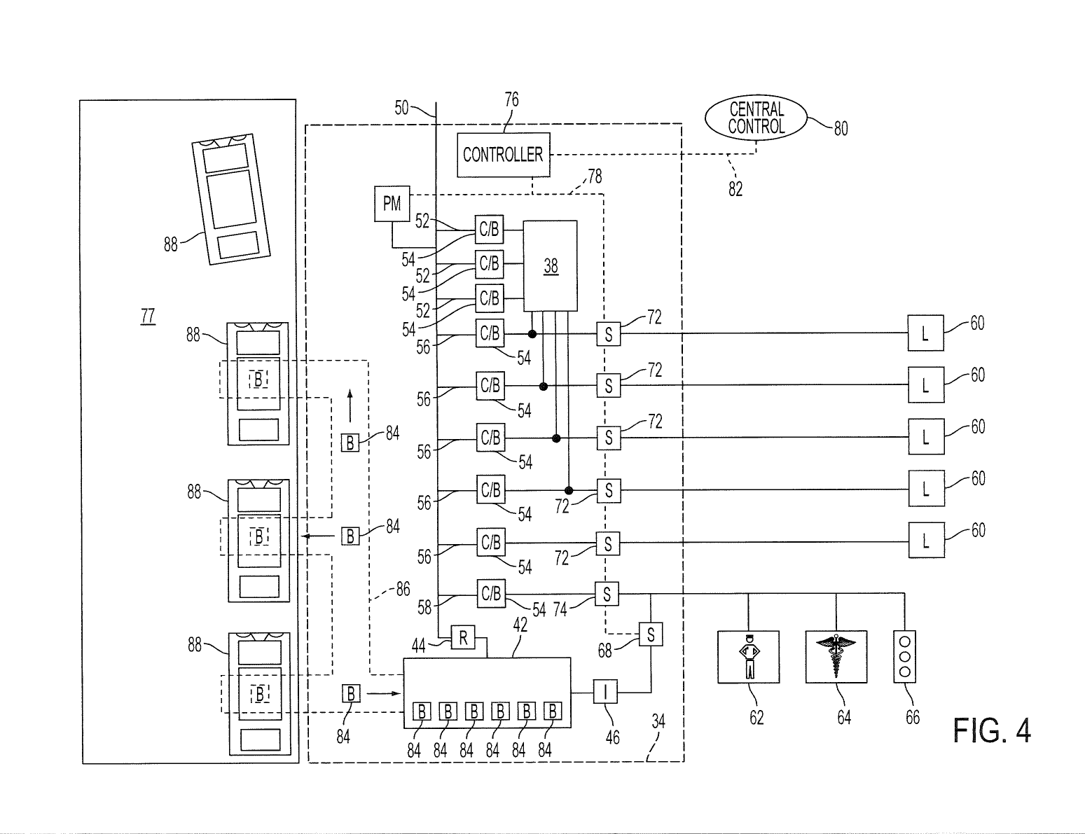

Another embodiment of substation 34 is illustrated in FIG. 4. In this embodiment, the conveyor system 86 includes multiple branches. This allows batteries from multiple vehicles 88 to be interchanged simultaneously. This may provide additional advantages in high volume areas or for fleet vehicles, including limousines, taxicabs, delivery vehicles and the like.

Another embodiment of the charging system may interconnect the battery storage in or adjacent to the substation via an overhead or underground conductor that charges onboard batteries in the vehicle via a connector, such as a connector complying with Society of Automotive Engineers (SAE) standard SAE J1772 for example, or contacts on the vehicle that are accessible from the outside and touching the contacts providing the charging current.

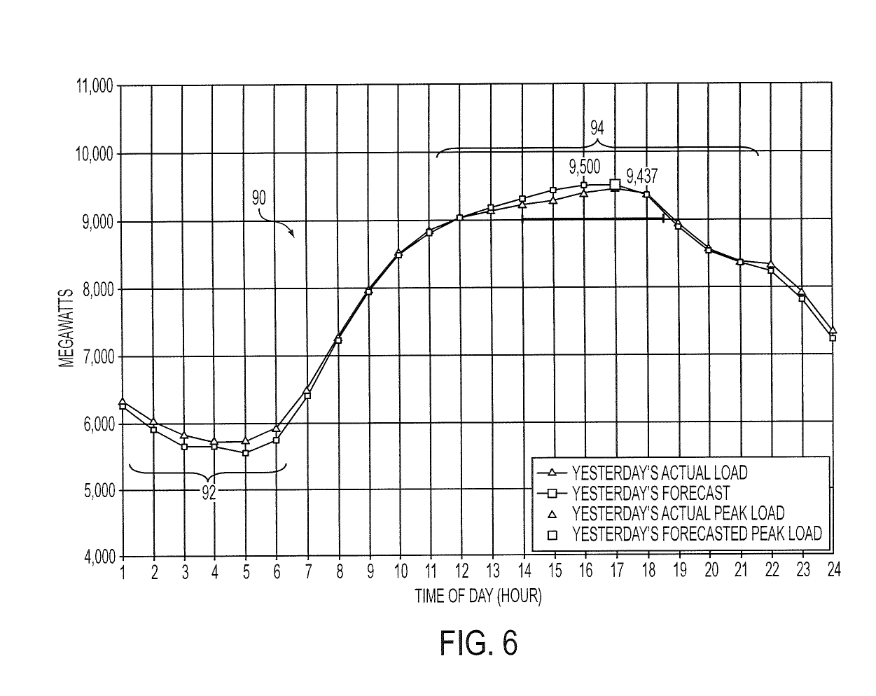

It should be appreciated that the demand for electrical power does not remain constant through out the day. As shown in FIG. 6, a typical electrical demand curve 90 includes defined periods of low demand and high demand, sometimes referred to as “off-peak period” 92 and “peak period” 94 respectively. It should be appreciated that these periods and the demand curve 90 in general may change from day to day depending on a variety of factors including the day of the week, the weather and the season. Generally, in most geographic regions, the off-peak period 92 corresponds to the early morning time period and the peak period 94 begins around 11 AM and extends into the early evening. Since electrical power must be consumed as it is generated, traditional electrical networks needed to balance demand for electricity with the generation. Where many smaller generators are used, this balancing act can be quite difficult. The use of renewable energy sources further add to the complexity since the network operator has an additional factor to consider in determining whether they can utilize the generator.

In the event that the demand greatly exceeds the ability of the electrical network to deliver, or where equipment malfunctions reduce the networks capacity, undesired events, such as blackouts and brownouts may occur. It should be appreciated that it is undesirable to lose power to public infrastructure or safety services, such as those connected to feeder 58 for example. The substation 34 having an energy storage device 42 can provide advantages in alleviating the impact of a blackout or brownout while also providing a convenient location for providing additional services to operators of vehicles having a form of electrical propulsion.

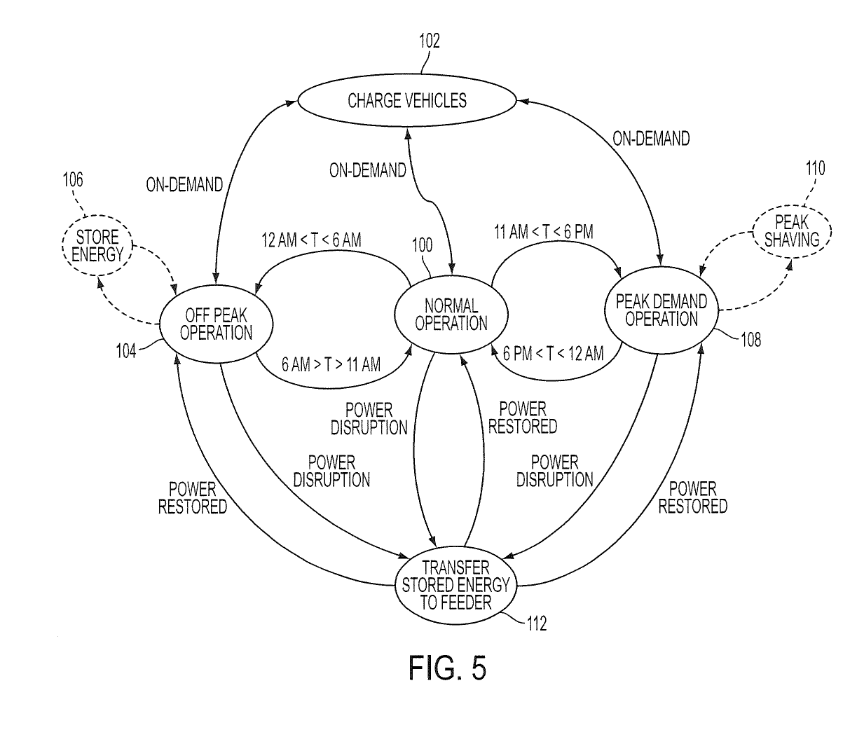

One embodiment of operating the substation 34 is illustrated in FIG. 5. This embodiment is carried out by the controller 76 and associated circuitry and may be described in terms of a finite state machine. Finite state machines, commonly referred to as state machines, are widely used for a variety of purposes, including controlling sequences of actions. A state machine is a model of behavior comprising states and transitions. A state represents the sequence of inputs to the state machine from its start to the present moment. A transition specifies a change in state from the current state, often, though not necessarily, as a result of one or more inputs received. In hardware, state machines are typically implemented as registers to store state variables and combinatorial logic gates to implement transitions and state machine outputs.

In one embodiment, the controller 76 operates in a normal state 100. The normal state 100 occurs between the off-peak period 92 and peak period 94. When in this state, the substation delivers electrical power received from the transmission system to end user loads. In the event that a vehicle or other end user loads that can be considered discretionary or interruptible 88 requires electrical power, the controller 76 transitions the operation of the energy storage device 42 to a charge state 102 where electrical energy is delivered to these loads 88, such as through connection 70, or by interchanging a battery 84 for example. It should be appreciated that the controller 76 may operate in states 100, 102 simultaneously.

During off-peak period 92, such as between 12 AM and 6 AM for example, the controller 76 shifts to an off-peak mode 104. Since the off-peak period 92 corresponds to lower electrical demand, the electrical network will typically have an overcapacity of lower cost electrical generation or excess wind power available. The off-peak mode 104 uses this overcapacity to store electrical energy 106 in the energy storage device 42. In the exemplary embodiment, the energy storage device 42 has a storage capacity at or greater than 100 megawatt-hours. It should be appreciated that while in off-peak mode 104, if the overcapacity of generation is not available, the controller 76 will route the power to the consumer loads rather than to the energy storage device 42. Similarly, if an overcapacity exists while in normal mode 100, the controller 76 may utilize this overcapacity to increase the amount of energy stored 106. At the end of the off-peak period 92, the controller 76 transitions back to normal mode 100.

In one embodiment, during the peak period 108, the controller transitions to peak mode 108. In this peak mode 108, the controller 76 draws on the energy from the energy storage device 42 and delivers the electrical energy to the loads coupled to substation 34, a process sometimes referred to as peak-shaving 110. In the embodiments of FIGS. 2-4, the controller 76 may utilize the energy stored in energy storage device 42 to provide electrical power to the feeder 58 by opening medium voltage switch 74 and closing medium voltage switch 68. In one embodiment, this transition of the switches occurs in a break-before-make procedure to prevent the flow of electrical power from two sources. By powering the feeder 58 with the energy storage device 42, the electrical power that would have otherwise gone to feeder 58 may be utilized by feeders 52, 56.

It should be appreciated that the controller 76 may enter a charge state mode 102 for charging of vehicles whether it is in normal mode 100, off-peak mode 104 or peak mode 108. In one embodiment, the controller 76 may prioritize the usage of the energy storage device based on pre-defined rules to either refuse to charge vehicles when electrical demand is high, or conversely disable the peak-shaving mode 110 so that sufficient stored energy is available to charge vehicles.

It should be further appreciated that it is desirable to provide electrical power to the feeder 58 at a high level of reliability since the loads on feeder 58 are beneficial to the general public welfare. In one embodiment, the controller 76 monitors the incoming power from connection 50 for properties or characteristics of a disruption in the flow of electrical power. If a disruption in the flow of electrical power on connection 50 is detected, or if a signal is received from central control facility 80 warning of a disruption, the controller 76 transitions to energy transfer mode 112. When in energy transfer mode 112, controller 76 provides electrical power to the feeder 58 so as to maintain the flow of electrical power to the public services loads 62, 64, 66 even if electrical power is no longer available from connection 50. In this manner, the electrical needs of personnel such as the police, doctors and traffic control may be fulfilled and the impact of the disruption to the flow of electrical power on connection 50 on public safety and welfare is minimized. Once electrical power is restored to connection 50, the controller 76 transitions back to the mode 100, 104, 108 that is appropriate for the time of day, of level of electrical demand. This function could provide electricity for loads in a community with back up power in the event of loss or limitation of the normal supply to the substation.

An embodiment of the invention may be embodied in the form of computer-implemented processes and apparatuses for practicing those processes. The present invention may also be embodied in the form of a computer program product having computer program code containing instructions embodied in tangible media, such as floppy diskettes, CD-ROMs, hard drives, USB (universal serial bus) drives, or any other computer readable storage medium, such as random access memory (RAM), read only memory (ROM), or erasable programmable read only memory (EPROM), for example, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing the invention. When implemented on a general-purpose microprocessor, the computer program code segments configure the microprocessor to create specific logic circuits. A technical effect of the executable instructions is to provide for the charging of vehicles having electrical propulsion and an auxiliary power source to loads coupled to a public or emergency services feeder circuit.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An energy storage system comprising:
an energy distribution facility, said energy distribution facility having at least one energy input and a plurality of energy outputs;
an energy storage device coupled to said at least one energy input and at least one of said plurality of energy outputs;
a charging station associated with said energy distribution facility, said charging station is configured to removably couple said energy storage device in one or more electric vehicles.

2. The energy storage system of claim 1 wherein said charging station is within said energy distribution facility.

3. The energy storage system of claim 1 wherein said charging station is geographically proximate to said energy distribution facility.

4. The energy storage system of claim 1 wherein said energy storage device is comprised of a plurality of removable energy storage units, said plurality of removable energy storage units arranged to be moved from said energy storage device into said one or more electric vehicles.

5. The energy storage system of claim 4 wherein said plurality of removable energy storage units are

6. The energy storage system of claim 4 wherein said plurality of removable energy storage units each include a charged electrolyte.

7. The energy storage system of claim 4 wherein said plurality of removable energy storage units are ultracapacitors.

8. The energy storage system of claim 1 further comprising a rectifier or motor generator set electrically coupled between said energy storage device and said at least one energy input.

9. The energy storage system of claim 8 further comprising an inverter or motor generator set electrically coupled between said energy storage device and said at least one of said plurality of energy outputs.

10. The energy storage system of claim 9 further comprising:
a switch electrically coupled between said inverter or motor generator set and said at least one of said plurality of energy outputs; and,
a controller operably coupled to said switch, wherein said controller includes a processor responsive to executable computer instructions when executed on the processor for closing said switch to allow electrical energy to flow from said energy storage device to said at least one of said plurality of energy outputs in response to a loss of electrical power from said at least one energy input.

11. An electrical substation comprising:
at least one electrical power input;
a plurality of transformers electrically coupled to said at least one electrical power input;
a plurality of feeder circuits electrically coupled to receive electrical power from said plurality of transformers and transmit electrical power to an end load;
an energy storage device electrically coupled to said at least one electrical power input; and,
a charging station operably coupled to said energy storage device, said charging station being configured to transfer electrical energy to at least one electrically powered vehicle.

12. The electrical substation of claim 11 wherein:
said plurality of feeder circuits includes a first feeder circuit electrically coupled to a first set of loads and a second feeder circuit electrically coupled to a second set of loads; and,
said first feeder circuit is removably electrically connected to said energy storage device.

13. The electrical substation of claim 12 wherein said first set of loads includes a set of essential infrastructure loads.

14. The electrical substation of claim 13 wherein said set of essential infrastructure loads include traffic control systems.

15. The electrical substation of claim 12 wherein said energy storage device has a storage capability of 1 to 1000 mega-watt hours of electrical energy.

16. An electrical substation adjacent a roadway, said electrical substation comprising:
an electrical source input line;
electrical equipment electrically coupled to said electrical source input line;
a plurality of feeder circuits electrically coupled to said electrical equipment, said plurality of feeder circuits including a first feeder circuit;
an energy storage device electrically coupled to said electrical equipment and said first feeder circuit;
a charging station arranged adjacent said roadway, said charging station being operably coupled to said energy storage device and at least one electrically powered vehicle; and,
a controller having a processor responsive to executable instructions, the executable instructions when executed on the processor for transferring electrical energy from said energy storage device to said charging station when electrical power is available from said electrical source input line.

17. The electrical substation of claim 16 wherein said processor is further responsive to executable instructions when executed on the processor for transferring electrical energy from said energy storage device to said first feeder circuit in response to a disturbance in the electrical power from said electrical source input line.

18. The electrical substation of claim 17 wherein said electrical source input line is electrically coupled to renewable energy power sources.

19. The electrical substation of claim 17 wherein said processor is further responsive to executable instructions when executed on the processor for storing energy from said electrical source input line in said energy storage device during a first time period.

20. The electrical substation of claim 19 wherein said processor is further responsive to executable instructions when executed on the processor for transferring electrical energy from said energy storage device to said first feeder circuit in response to an electrical demand on said plurality of feeder circuits exceeding a threshold.

21. The electrical substation of claim 19 wherein said processor is further responsive to executable instructions when executed on the processor for transferring electrical energy from said energy storage device to said first feeder circuit during a second time period.

22. A method of operating an electrical substation and vehicle charging system comprising:
receiving electrical energy from a source;
storing electrical energy in an energy storage device;
transferring electrical energy from said energy storage device to a vehicle;
coupling a first feeder to said energy storage device and said source;
transferring electrical energy from said source to said first feeder; and,
transferring electrical energy from said energy storage device when there is a disruption in the transfer of electrical energy from said source.

23. The method of claim 22 wherein said storing electrical energy in said energy storage device occurs during a first time period.

24. The method of claim 23 wherein said first time period corresponds to a time period of low electrical demand or excess generation from a plurality of feeders coupled to said electrical substation.

25. The method of claim 24 further comprising transferring electrical energy from said energy storage device to said first feeder during a second time period.

26. The method of claim 25 wherein said second time period corresponds to a time period of high electrical demand or limited supply from said plurality of feeders.

27. The method of claim 23 wherein said step of transferring electrical energy to said vehicle includes transferring at least one battery from said energy storage device and retrieving at least one battery from said vehicle.
